(19) United States
(12) Patent Application Publication
(10) Pub. No.: US 2014/0003754 A1
(43) Pub. Date: Jan. 2, 2014

(54) WATER-CONDUCTING HOUSEHOLD APPLIANCE HAVING A MOVEABLE COMPONENT

(71) Applicants: Jùrgen Heß, Berlin (DE); Vladimir Proseanic, West Bloomfield, MI (US); Boris Zlotin, West Bloomfield, MI (US)

(72) Inventors: Jùrgen Heß, Berlin (DE); Vladimir Proseanic, West Bloomfield, MI (US); Boris Zlotin, West Bloomfield, MI (US)

(73) Assignee: BSH Bosch und Siemens Hausgerate GmbH, Munich (DE)

(21) Appl. No.: 13/534,358

(22) Filed: Jun. 27, 2012

(51) Int. Cl. F16C 33/66; F16C 19/00

(52) U.S. Cl. 384/490

(57) ABSTRACT

A water-conducting household appliance includes movable component which is moveably mounted on a stationary component of the household appliance by way of a metallic bearing. A sacrificial material with a lower electrochemical potential compared with the metallic material of the bearing in a bearing chamber, in which the bearing is arranged, prevents corrosion of the bearing. The sacrificial material rusts instead of the bearing.

### BACKGROUND OF THE INVENTION

The invention relates to a water-conducting household appliance having a moveable component, which is moveably mounted on a stationary component of the household appliance by way of a bearing formed from a metallic material, the bearing being arranged within a bearing chamber. The invention also relates to a use.

Interest presently focuses on a household appliance for the care of items of laundry, in which a laundry drum is rotatably arranged on a wash tub by way of a bearing. The bearing, for instance a ball-bearing, is usually found within a bearing chamber, which, by means of a seal, is separated for liquids and sealed from the interior of the wash tub. It is already prior art that the bearing chamber is filled with lubricating oil or lubricating grease, subsequently combined under the term “bearing grease”. The bearing grease here assumes two different functions, namely on the one hand the function of lubricating the metallic ball-bearing and on the other hand the function of keeping water from the ball-bearing. Within such an application, the metallic ball-bearing is a component which is sensitive to corrosion. Indeed, the bearing chamber, as already mentioned, is separated from the wash tub, which can be filled with water, with the aid of a seal, but the possibility of individual droplets of water entering the bearing chamber over the entire service life of the household appliance cannot be excluded.

Three conditions must be fulfilled for rust to form on the ball-bearing. Rust-sensitive metal (e.g. iron or an iron-based alloy), water and oxygen must be present. Rust in this case refers to a complex corrosion product which is formed from metal by means of oxidation with oxygen in the presence of water. Rust is therefore an oxide containing water, namely an agglomeration of iron, oxide and hydroxide ions with water. With respect to the formation of rust, reference is made to FIG. 1 of the appended drawing, in which a component 1 formed from iron Fe corrodes on account of a droplet of water 2 present. If the iron component 1 comes into contact with water, damp air, or another electrolyte, the oxygen dissolved in the water attacks the metal, this being termed as “oxidation”. A galvanic cell is formed, so that electrons can be removed from the metal and positively charged ions pass into the solution. Thus the metal corrodes. This is disadvantageous particularly in a washing machine. The corroded bearing results in a marked development of noise in the washing machine, namely during spinning This frequently results in unnecessary costs, since the entire bearing can only be replaced with a relatively large outlay.

### BRIEF SUMMARY OF THE INVENTION

An object of the invention is to demonstrate a solution as to how, with a household appliance of the type cited in the introduction, the bearing can be particularly reliably protected from corrosion.

An inventive water-conducting household appliance thus includes a moveable component, which is moveably mounted on a stationary component of the household appliance by way of a bearing formed from a metallic material, in particular iron. The bearing is generally sensitive to corrosion. The bearing is arranged within a bearing chamber, which is preferably separated for liquids from a liquid chamber of the household appliance with the aid of a seal, it being possible to fill the liquid chamber with water. The bearing chamber is preferably also filled with bearing grease. Provision is made in accordance with the invention for a sacrificial material having a lower electrochemical potential compared with the metallic material of the bearing to be arranged and available in the bearing chamber in order to prevent corrosion of the bearing.

The invention makes use of the principle of the so-called “sacrificial anode”, which can be used to prevent corrosion of a component formed from a metallic material. In order to prevent corrosion of the bearing, the present invention determines to use the cathodic corrosion protection according to the sacrificial anode principle. For this purpose, a sacrificial material is used in the bearing chamber, which, in the electrochemical series, is more negative than the metallic material of the bearing, in particular more negative than iron. An electrically conductive connection between the sacrificial material on the one hand and the bearing to be protected on the other hand produces a primary element, in which the bearing to be protected functions as a cathode and the sacrificial material as an anode, so that an electrical current flows in the direction of the bearing to be protected. The sacrificial material, and not the metallic bearing, now provides its electrons to the oxygen and is oxidized. This enables the metallic bearing to be reliably protected from corrosion, so that the noise development of the household appliance can also be prevented over a very long time period, preferably throughout its whole service life.

It has proven particularly advantageous if the household appliance is a device for caring for items of laundry, namely in particular a washing machine, a tumble dryer or a washer-dryer. The moveable component is then a laundry drum for receiving items of laundry. By contrast the stationary component may be a wash tub, which is used as a liquid chamber to receive liquid such as water and washing or rinsing liquid. Even with such household appliances, the metallic bearing should be particularly reliably protected.

The bearing chamber, in which the metallic bearing is arranged, is preferably separated for liquids in a sealed manner from a liquid chamber (for instance wash tub) for liquids, which can be filled with water. A seal is preferably used to seal the bearing chamber from the liquid chamber, namely in particular a radial shaft seal. It is therefore avoided that water from the liquid chamber can reach the bearing chamber. Nevertheless it is not possible to exclude the possibility of droplets of water entering the bearing chamber entirely; nevertheless in this case the sacrificial material assumes the function of protecting the metallic bearing from corrosion.

In an exemplary embodiment, provision is made for the bearing chamber to be filled with bearing grease and the sacrificial material to be mixed in with the bearing grease in particular in the manner of a suspension. The sacrificial material is thus basically available at any point in the bearing chamber, and each individual surface piece of each individual metallic component of the bearing, which is connected to the bearing grease, in particular each individual ball in the bearing, can thus be protected from corrosion. This embodiment also enables a particularly reliable protection of a ball bearing, in which the attachment of a conventional sacrificial anode on each individual component of the bearing is not possible. Mixing the sacrificial material with the bearing grease therefore particularly prevents the corrosion of individual balls of a ball-bearing.

In an exemplary embodiment the sacrificial material is provided in the form of fine particles. It is therefore possible for the sacrificial material to always be in electrical contact with all the components of the bearing in the presence of droplets of water.

To ensure that the electrical connection between the sacrificial material and the metallic material of the bearing is always established, the size of a particle of the sacrificial material is preferably smaller than the size of an individual droplet of water. The corrosion protection of the metallic bearing is thus at a maximum.

With respect to the sacrificial material itself, different embodiments can be provided.

In one exemplary embodiment provision is made for the sacrificial material to be aluminum. This is advantageous in that the aluminum powder is available in various forms on the market, namely with various particle sizes. This embodiment is thus relatively cost-effective to implement.

In addition or alternatively, provision can also be made for the sacrificial material to be zinc, in other words a chemical element with the element symbol Zn and the atomic number 30. Aside from the advantages of aluminum, zinc is also advantageous in that the electrochemical potential difference between zinc and iron is clearly less than with aluminum. The duration of the protective effect is thus also clearly longer than with aluminum. Furthermore, the educts of the zinc oxidation are essentially softer and their contribution to abrasive wear is therefore also clearly less than with aluminum.

In an exemplary embodiment, provision is made for the bearing grease to be suitably modified in order to exhibit electrical conductivity. To this end for instance, an electrically-conductive polymer is suitable, which is found in the bearing chamber in addition to the sacrificial material. This means in particular that the bearing grease is doped with such an electrically conductive polymer. An organic polymer is preferably used as a polymer, preferably in the form of fine particles. This embodiment is advantageous in that the electrical conductivity between the metallic bearing and the sacrificial material can be improved. In particular, the afore-cited restriction in terms of size of the particles of the sacrificial material can thus be avoided.

Soot or carbon particles are mixed in with the sacrificial material for instance. This means in particular that the bearing grease in the bearing chamber is doped with soot particles, which improve the electrical conductivity of the medium found in the chamber.

Advantageously, the surface energy of the mixture of bearing grease and if necessary water found in the bearing chamber can also be modified and/or explicitly adjusted. This modification enables the size of the droplets of water found in the bearing grease to be explicitly modified and the corrosion protection to be further improved.

The invention also relates to a use of the principle of a sacrificial anode to prevent corrosion in a household appliance, namely in particular to prevent the corrosion of a bearing, on which a moveable component of the household appliance is mounted. The preferred embodiments presented with respect to the inventive household appliance and their advantages apply accordingly to the inventive use.

Further features of the invention appear from the claims, the figures of the appended drawing and the subsequent description of these figures. All the features and feature combinations shown in the description as well as the features and feature combination cited below and/or shown in isolation in the figures cannot only be used in the specified combination in each instance but also in other combinations or even in isolation.

### BRIEF DESCRIPTION OF THE DRAWINGS

The invention is now explained in more detail by means of an exemplary embodiment, and also described in more detail with reference to the figures of the appended drawing, wherein:

FIG. 1 shows a schematic representation to explain the formation of corrosion;

FIG. 2 shows a schematic representation of a moveable component of a household appliance according to an embodiment, wherein the moveable component is mounted on a stationary component by way of a bearing;

FIG. 3 shows a schematic representation of the bearing, which is found in a bearing chamber, and

FIG. 4 shows a schematic representation to explain the principle of a sacrificial anode.

### DETAILED DESCRIPTION OF EXEMPLARY EMBODIMENTS OF THE PRESENT INVENTION

FIG. 2 shows a schematic representation of internal components of a washing machine according to one embodiment. A laundry drum 3 is used to receive items of laundry and is rotatably mounted about an axis of rotation 4 running horizontally. The laundry drum 3 is connected to a pulley 6 by way of a shaft 5. Whereas the laundry drum 3 lies within a stationary wash tub 7, the pulley 8 is located outside of the wash tub 7. The laundry drum 3 represents a moveable component of the washing machine and the wash tub 7 represents a stationary component of the washing machine.

The laundry drum 3 is rotatably mounted on the wash tub 7. To this end, a bearing apparatus 8 is provided, which includes a bearing housing 9 and a bearing 10 arranged in the bearing housing 9. The bearing 10 is a ball-bearing in the exemplary embodiment.

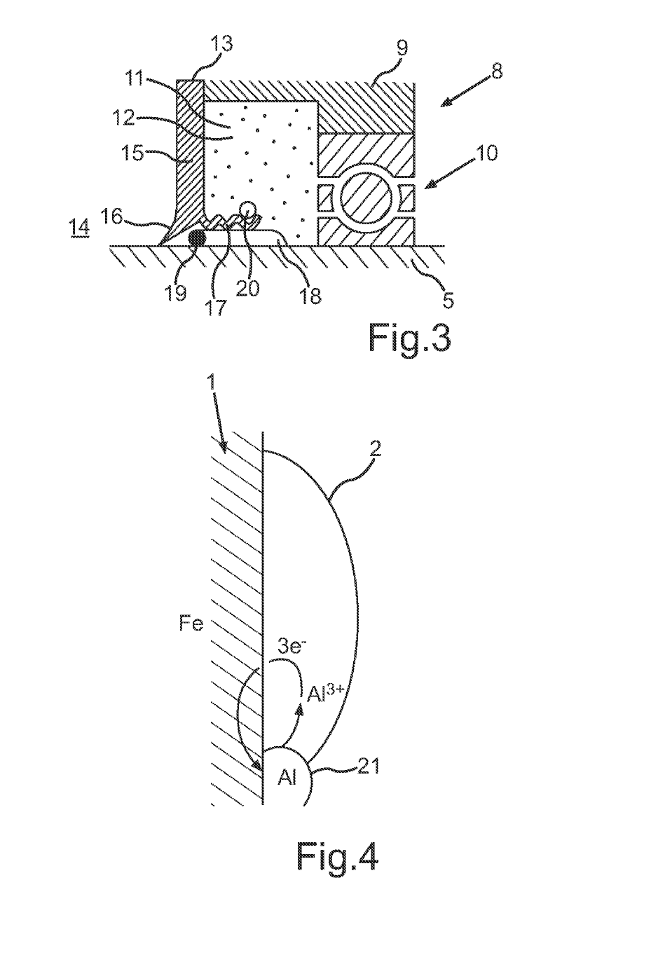

An enlarged representation of the bearing apparatus 9 is shown schematically in FIG. 3. The bearing 10 is in a bearing chamber 11, which is filled with bearing grease 12. The bearing chamber 11 is sealed off from the interior 14 of the wash tub 7 and/or from the interior of the laundry drum 3 with the aid of a seal 13 (here shaft seal). The seal 13 is provided in the form of a peripheral ring. It is embodied to be L-shaped in the longitudinal section and includes a radially preceding annular element 15, from which, in the region of the shaft 5, two lips project in the axial direction, namely on the one hand a first lip 16 in the axial direction to the interior 14 and on the other hand a second lip 17 in the axial direction to the bearing chamber 11. While the first lip 16 rests directly on the shaft 5 and thus prevents the penetration of water into the bearing chamber 11, the second lip 17 rests in the radial direction on a sliding ring 18, which is connected to the shaft 5 and is sealed at one end facing the interior 15 with a O-ring 19. The sliding ring 18 therefore represents a sleeve, which is clipped onto the shaft 5 for instance. The second lip 17 is pushed in the radial direction to the sliding ring 18 with the aid of a spiral spring 20 and is thus secured in its position. It represents a second sealing barrier, the sealing effect of which is improved still further by the pressing force of the spiral spring 20.

Even with a particularly reliably sealed bearing chamber 11 of this type, it is not possible to exclude the possibility through the entire service life of the washing machine of droplets of water entering the bearing chamber 11 to 100%. It is proposed for this reason to use a sacrificial material in the bearing chamber 11, which prevents the corrosion of the bearing 10 in accordance with the sacrificial anode principle. Namely, the sacrificial material includes a lower electrochemical potential compared with the metallic material of the bearing 10, for instance iron or iron-based alloy, and is thus more negative than the metallic material of the bearing 10 in the electromotive series. In this case it is ensured that the sacrificial material is always electrically connected to the bearing 10. A primary element is then produced, in which the bearing 10 to be protected functions as a cathode and the sacrificial material functions as an anode. Instead of the bearing 10, the sacrificial material now releases its electrons into the oxygen and oxidizes with the result that the sacrificial material corrodes instead of the bearing 10.

In order to ensure the electrical contact between the bearing 10 and the sacrificial material, the sacrificial material is provided in the form of fine particles, which are mixed in with the bearing grease 12. The size of these particles may in particular be smaller than the size of a droplet of water, so that the electrical connection between the sacrificial material and the bearing 10 is ensured. In such cases aluminum and/or zinc can be used as the sacrificial material. Polymer particles or soot particles can be mixed in with the bearing grease 12, as a result of which the electrical conductivity of the medium found in the bearing chamber 11 is improved.

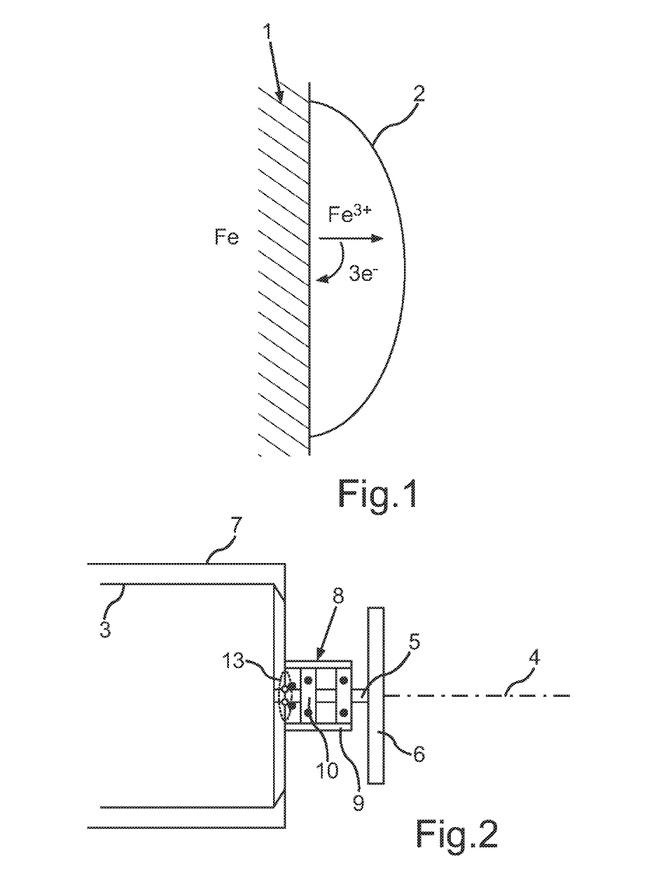

The effect of the sacrificial material is explained in more detail with reference to FIG. 4. Unlike the representation according to FIG. 1, a sacrificial particle 21 made of the sacrificial material, here aluminum, is now found on the component 1 embodied from iron. As apparent from FIG. 4, the size of this sacrificial particle 21 is clearly smaller than the size of the droplet of water 2. The component 1 to be protected here functions as a cathode, whereas the sacrificial particular 21 here functions as an anode. An electrical current flows in the direction of the component 1, so that instead of this, the less noble sacrificial material releases its electrons to the oxygen and oxidizes.

1. A water-conducting household appliance comprising:
a stationary component;
a metallic bearing in a bearing chamber;
a rotatable component rotatably mounted on the stationary component by the metallic bearing; and
a sacrificial additive in the bearing chamber to prevent corrosion of the metallic bearing, the additive operating as a sacrificial anode under the principle of a sacrificial anode, wherein the bearing chamber contains bearing grease and the additive is mixed in the bearing grease.

2. The household appliance of claim 1, wherein the bearing chamber is separated from a liquid chamber to receive water.

3. (canceled)

4. The household appliance of claim 1, further comprising an electrically-conductive organic material mixed in the bearing grease.

5. The household appliance of claim 4, wherein the electrically-conductive organic material comprises an electrically-conductive polymer.

6. The household appliance of claim 1, further comprising soot particles mixed in the bearing grease.

7. The household appliance of claim 1, wherein the additive is particles.

8. The household appliance of claim 7, wherein the particles are suspended in the bearing grease.

9. (canceled)

10. The household appliance of claim 1, wherein the additive comprises a material which is below iron in the electrochemical series.

11. The household appliance of claim 1, wherein the additive comprises aluminum.

12. The household appliance of claim 1, wherein the additive comprises zinc.

13. The household appliance of claim 1, wherein the bearing chamber is filled with the bearing grease.

14. The household appliance of claim 13, wherein the additive is suspended in the bearing grease.

15. The household appliance of claim 14, further comprising an electrically-conductive organic material mixed in the bearing grease.

16. The household appliance of claim 15, wherein the electrically-conductive organic material comprises an electrically-conductive polymer.

17. The household appliance of claim 15, further comprising soot particles mixed in with the bearing grease.

18. The household appliance of claim 1, wherein the additive is suspended in the bearing grease.

19. The household appliance of claim 18, further comprising an electrically-conductive organic material mixed in the bearing grease.

20. The household appliance of claim 19, wherein the electrically-conductive organic material comprises an electrically-conductive polymer.

21. The household appliance of claim 18, further comprising soot particles mixed in with the bearing grease.

22. The household appliance of claim 1, further comprising
a water chamber configured to contain water; and
a seal,
wherein the water chamber is separated from the bearing chamber by the seal,
the additive is in the form of particles suspended in the bearing grease, and
the additive prevents the corrosion of the bearing by supplying electrons to water that moves past the seal from the water chamber to the bearing chamber.
